(19) United States
(12) Patent Application Publication
(10) Pub. No.: US 2006/0204822 A1
(43) Pub. Date: Sep. 14, 2006

(54) Start control device applied to fuel cell system and its control methods available

(75) Inventors: Hsi-Ming Shu, Taipei (TW); Ching-Tang Chan, Taipei (TW)

Correspondence Address: G. LINK Co.,LTD, 3550 Bell Road, MINOOKA, IL, 60447, US

(73) Assignee: ANTIG TECHNOLOGY Co,Ltd.

(21) Appl. No.: 11/076,125

(22) Filed: Mar. 10, 2005

(51) Int. Cl. H01M 2/08; B32B 7/12

(52) U.S. Cl. 429/35; 428/343

(57) ABSTRACT

The present invention provides a start control device applied to a fuel cell system, which includes: a stickup-type separator, which can be stuck tightly at cathodes of the fuel cell system, or be separated from the cathodes, and it can separate the cathodes of the fuel cell system from the ambient air under tightly sticking state while can circulate the ambient air around the cathodes of the fuel cell system under the separating state.

### FIELD OF THE PRESENT INVENTION

The present invention is related to a fuel cell system, which particularly is related to a start control device and its control methods available which would make the fuel cell system be interrupted easily or continue its chemical reaction to control the supply of electric power in the fuel cell system.

### BACKGROUND OF THE INVENTION

The prior techniques in some cases how to interrupt the chemical reaction in fuel cell system immediately for making the fuel cell system stopping its generation of electric power are wanting. Because electric appliances of fuel cell system made with prior techniques are short of the design principle to interrupt the chemical reaction, they can stop the supply of electric power after the fuel in the fuel cell system burnt out. That is the obvious defect of prior techniques.

Whereas, the inventor of the present invention invented a start control device applied to fuel cell system and its control methods considering abovementioned defect of the prior techniques, and users can use it like a switch to interrupt or continue conveniently the chemical reaction of the fuel cell system for control the supply of electric power in the fuel cell system.

### SUMMARY OF THE INVENTION

The present invention mainly provides a start control device applied to fuel cell system and its control methods, and users can use it like a switch to interrupt or continue conveniently the chemical reaction of the fuel cell system for control the supply of electric power in the fuel cell system.

Additionally, another purpose of the present invention is to provide a most effective, quick and economical method to interrupt chemical reaction of the fuel cell system at the time of inputting methanol fuel into the direct methanol fuel cell firstly.

For abovementioned purpose, the present invention provides a start control device applied to a fuel cell system, which includes: a stickup-type separator, which can be stuck tightly at cathodes of the fuel cell system, or be separated from the cathodes, and it can separate the cathodes of the fuel cell system from the ambient air under tightly sticking state while can circulate the ambient air around the cathodes of the fuel cell system under the separating state.

Additionally, for abovementioned purpose, the present invention provides a start control method applied to a fuel cell system, which comprises the following steps: provide a fuel cell system; make the start control device be stuck tightly at cathodes of the fuel cell system to isolate the cathodes of the fuel cell system from the ambient air completely, so that the chemical reaction in the fuel cell system can be interrupted; and, separate start control device from the cathodes of the fuel cell system to circulate the circulate the ambient air around the cathodes of the fuel cell system under the separating state for continuing the chemical reaction.

### BRIEF DESCRIPTION OF THE DRAWINGS

The above objects and advantages of the present invention will become more apparent with reference to the appended drawings wherein:

FIG. 1 is the exploded view of the present invention;

FIG. 2 is the elevational view while the cathodes of fuel cell system are stuck by a separator;

FIG. 3 is the elevational view while the separator tears from the cathodes of fuel cell system;

FIG. 4 is the elevational view while the present invention used in other fuel cell system; and

FIG. 5 is the flow chart for control methods of the present invention.

### DETAILED DESCRIPTION OF THE INVENTION

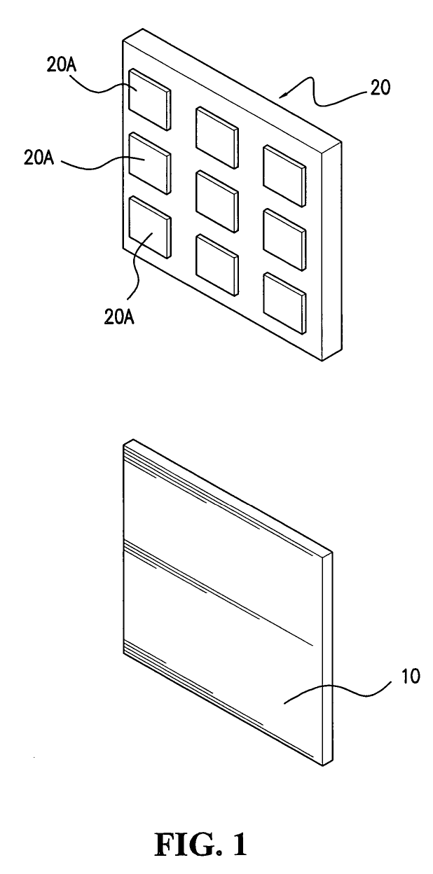

FIG. 1 is the exploded view of the present invention. The start control device 10 mainly can be stuck tightly on the cathodes 20A of the fuel cell system 20, or torn from the cathodes 20A of the fuel cell system 20, so that user can control the fuel system 20 and know whether it has the conditions to have chemical reaction for the generation of electric power while the cathodes under tightly sticking or separating state, and can directly control (ON/OFF) the power of the fuel cell system 20 like using a switch to turn on or off the power supply.

Taking the embodiment of the direct methanol fuel cell system 20 to describe the action mechanism, the chemical formula for the anode of direct methanol fuel cell system 20 is as follows:
CH₃OH+H₂O→6H⁺+6e⁻+CO₂
The chemical formula for the cathode of direct methanol fuel cell system 20 is as follows:
1.5O₂+6H⁺+6e⁻→3H₂O
The overall reaction is as follows:
CH₃OH+H₂O+1.5O₂→3H₂O+CO₂
Through observation on the equations, we find out that the supply of O₂ is the necessary condition for the sufficient reaction of the direct methanol fuel cell system 20. If stop the supply of the O₂, the direct methanol fuel cell system 20 fails to make the electrochemical reaction, i.e. the generation of the power supply of the direct methanol fuel cell system 20 would be stopped.

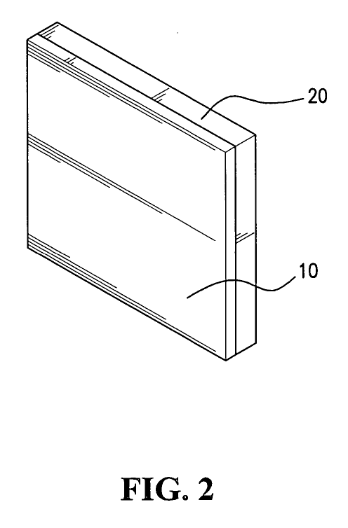

FIG. 2 is the elevational view while the cathodes of fuel cell system are stuck by a separator. As shown in FIG. 2, the start control device 10 is a separator factually. If user sticks tightly the separator 10 on the cathodes 20A of the fuel cell system 20, the cathodes 20A would fail to get the supply of ambient air that results in the chemical reaction interrupted and the generation of the electric power stopped.

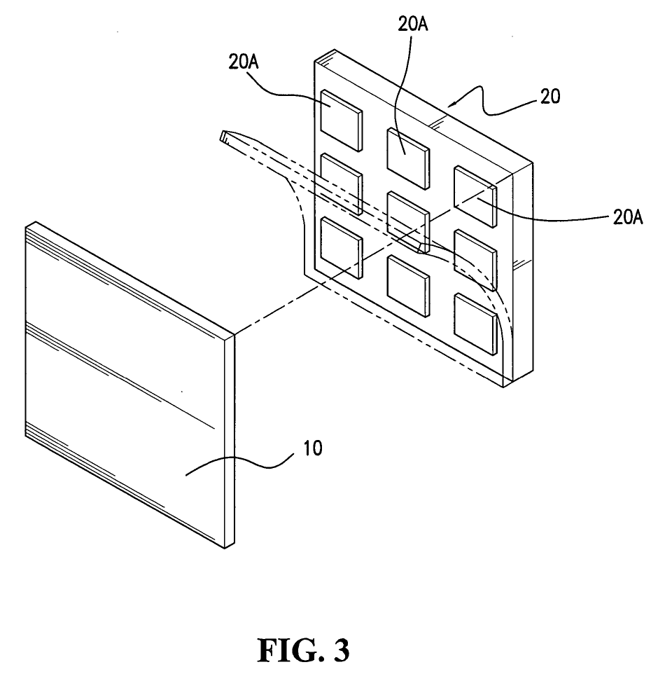

FIG. 3 is the sketch map while the separator tears from the cathodes of fuel cell system. After the users tears the separator 10 from the cathodes 20A of the fuel cell system 20, the chemical reaction in the fuel cell system 20 can be continued smoothly and power would be generated because the cathodes 20A can get the ambient air; additionally, If the user sticks the separator 10 on the cathodes 20A of the fuel cell system 20 again under the state as shown in FIG. 3, the state as shown in FIG. 2 would be recovered immediately. And the power in the fuel cell system would not be generated when the separator 10 is stuck tightly. User can obtain the state as shown in FIG. 2 and FIG. 3 repeatedly to control (ON/OFF) the electric power of the fuel cell system 20 like using a switch.

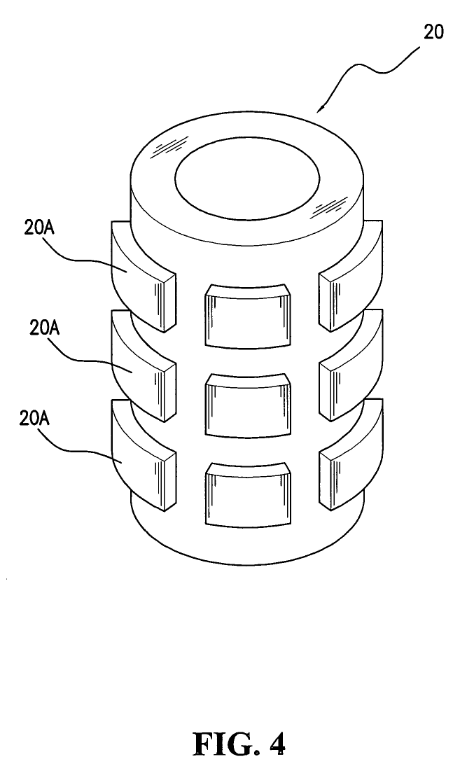

The fuel cell system 20 the start control device 10 applied to is the one made through the manufacture procedures of hard or soft printing circuit board (PCB), as shown in FIG. 4, which is the elevational view of the present invention used in other fuel cell system. The start control device 10 particularly is applied to interrupting the chemical reaction of the fuel cell system at the time of inputtting methanol fuel into the direct methanol fuel cell firstly, whose functions can be fulfilled immediately with a most effective, quick and economical method, i.e. stick the separator 10 on the cathodes 20A of the fuel cell system 20.

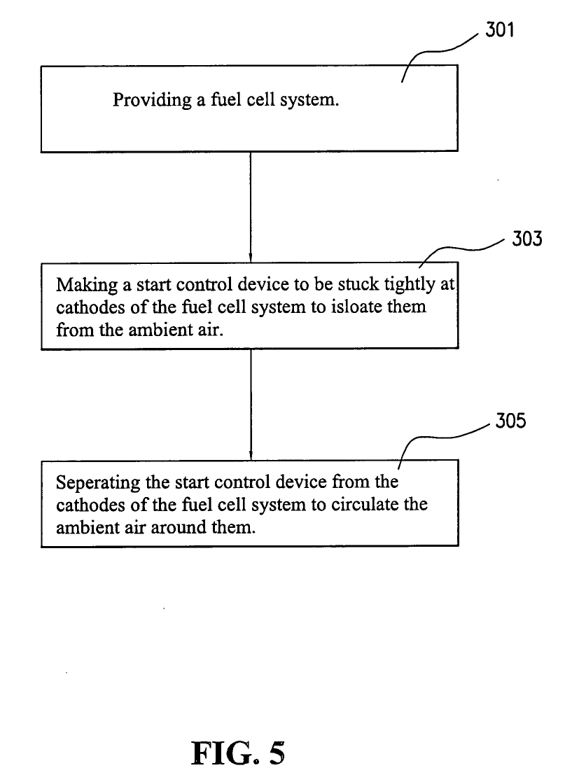

FIG. 5 is the flow chart for control methods of the present invention. The start control method 30 applied to the fuel cell system 20 mainly comprises step 301, 303 and 305 as follows. In step 301, it is to provide the fuel cell system 20, which may be the direct methanol fuel cell 20 according to the abovementioned description. In step 303, it is to make the start control device 10 be stuck tightly at cathodes 20A of the fuel cell system 20 to isolate the cathodes 20A of the fuel cell system 20 from the ambient air completely, so that the chemical reaction in the fuel cell system 20 can be interrupted. In step 305, it is to separate start control device 10 from the cathodes 20A of the fuel cell system 20 to circulate the ambient air around the cathodes 20A of the fuel cell system 20 under the separating state for continuing the chemical reaction. Based on the description above, the start control device 10 in the step 303 and 305 can be implemented as a separator.

The abovementioned separator 10 can be made of any kind of materials which has good isolation from the ambient air such as poly vinyl chloride resin. The separator 10 should in principle cover the whole cathodes of the fuel cell system 20.

Furthermore, the separator can be made by fresh-keep film, which would be used for covering and sealing the whole fuel cell system to isolate the ambient air from the cathodes of fuel cell system.

The present invention is not restricted to the good embodiment described above. Anyone who knows well this technique can modify and embellish it a little based on the principle not away from the essence and claims of the present invention, and the modification and embellishment belong to the further claims of the present invention.

What is claimed is:

1. A start control device applied to fuel cell system, comprising:
a stickup-type separator, which can be stuck tightly at cathodes of a fuel cell system, or be separated from the cathodes, and it can separate the cathodes of the fuel cell system from the ambient air under tightly sticking state while can circulate the ambient air around the cathodes of the fuel cell system under the separating state.

2. The start control device applied to fuel cell system according to claims 1, wherein the stickup-type separator is made from poly vinyl chloride resin.

3. The start control device applied to fuel cell system according to claims 1, wherein the stickup-type separator is a kind of material which has good isolation from ambient air.

4. The start control device applied to fuel cell system according to claims 1, wherein the fuel cell system is a direct methanol fuel cell.

5. The start control device applied to fuel cell system according to claims 1, wherein the stickup-type separator is a kind of fresh-keep film, which would be used for covering and sealing the whole fuel cell system to isolate the ambient air from the cathodes of fuel cell system.

6. A start control method applied to fuel cell system, which comprises the following steps:
providing a fuel cell system;
making a start control device be stuck tightly at cathodes of the fuel cell system to isolate the cathodes of the fuel cell system from the ambient air completely, so that the chemical reaction in the fuel cell system can be interrupted; and
separating the start control device from the cathodes of the fuel cell system to circulate the ambient air around the cathodes of the fuel cell system under the separating state for continuing the chemical reaction.

7. The start control method applied to fuel cell system according to claim 6, wherein the start control device is a separator.

8. The start control method applied to fuel cell system according to claim 7, wherein the separator is stickup-type one.

9. The start control method applied to fuel cell system according to claim 7, wherein the separator is made from poly vinyl chloride resin.

10. The start control method applied to fuel cell system according to claim 7, wherein the separator is a kind of material which has good isolation from ambient air.

11. The start control method applied to fuel cell system according to claim 6, wherein the fuel cell system is a direct methanol fuel cell.

12. The start control method applied to fuel cell system according to claim 7, wherein the separator is a fresh-keep film, which would be used for covering and sealing the whole fuel cell system to isolate the ambient air from the cathodes of fuel cell system.
